(19) United States
(12) Patent Application Publication
(10) Pub. No.: US 2010/0326298 A1
(43) Pub. Date: Dec. 30, 2010

(54) CONTINUOUS INK STAMPING SYSTEMS AND METHODS WITH RECONFIGURABLE STAMPING ASSEMBLY

(75) Inventor: Mark G. Patterson, Bellingham, WA (US)

Correspondence Address: SCHACHT LAW OFFICE, INC., SUITE 202, 2801 MERIDIAN STREET, BELLINGHAM, WA, 98225-2412, US

(73) Assignee: CLEARSNAP HOLDING, INC., Burlington, WA (US)

(21) Appl. No.: 12/822,087

(22) Filed: Jun. 23, 2010

Related U.S. Application Data
(60) Provisional application No. 61/222,073, filed on Jun. 30, 2009.

(51) Int. Cl. B41K 1/22; B41F 33/00

(52) U.S. Cl. 101/329; 101/483

(57) ABSTRACT

A stamp wheel assembly adapted for use as part of an ink stamp system comprising an axle assembly and first, second, and third wheel members. Each of the first, second, and third wheel members defines a stamp surface. At least two of the first, second, and third wheel members are supported by the axle assembly in a plurality of configurations. At least two of the first, second, and third wheel members are supported by the axle assembly in the plurality of configurations to define a plurality of angular relationships among the at least two of the first, second and third wheel members. The stamp surfaces of the at least two of the first, second, and third wheel members supported by the axle assembly in the plurality of configurations define a plurality of ink images. At least two of the plurality of ink images are unique.

### RELATED APPLICATIONS

This application (Attorney Matter No. P216439) is a non-provisional of U.S. Patent Application Ser. No. 61/222,073, filed Jun. 30, 2009.

The contents of all related applications are incorporated herein by reference.

### TECHNICAL FIELD

The present invention relates to systems and methods for forming ink impressions on paper and, more specifically, to such systems and methods that employ a stamping wheel that is rolled along an image surface to form a continuous ink impression.

### BACKGROUND

The present invention relates to ink stamping systems and methods in which an ink impression is formed on an image surface. The ink is applied to a stamp member on which a design is formed in bas relief. The stamp member with ink thereon is brought into contact with the image surface such that ink is transferred to the image surface to form an ink impression or image in a configuration corresponding to the design on the stamp member.

The present invention is of particular importance in the formation of artistic rather than commercial ink impressions. Art stamping uses the same basic ink stamping process as commercial ink stamping but has evolved to allow much finer control over the details and quality of the resulting ink impression. The principles of the present invention may also have application to commercial ink stamping, however.

Ink stamping systems for use by art stampers are designed and constructed primarily to obtain a high quality ink impression, with flexibility of use also being of importance. Considerations such as repeatability of the ink impression, ease of use, and durability of the stamping devices are of lesser importance than in the commercial ink stamping environment.

Ink pad or inking assemblies that form a continuous, repeated ink image are well-known. Such inking assemblies comprise a cylindrical stamping wheel comprising a stamp member defining a cylindrical stamping surface. The design formed in bas relief on the stamp member is formed on the outer surface of the stamp member. The stamp member is mounted on a handle or handle assembly such that the handle can be grasped to roll the stamp member along an ink pad and then along an inking surface to form the desired ink impression on the inking surface. In some continuous inking assemblies, the ink pad is also mounted to the handle such that ink is continuously applied to the outer member of the stamp member as the stamp member rolls along the inking surface.

Other such continuous inking assemblies are disclosed in U.S. Pat. Nos. 4,817,526 for a Rolling Contact Printer with Retractable Inking Wheel, 6,659,007 for Continuous Ink Stamping Systems and Methods, and 7,194,954 for Continuous Ink Stamping Systems And Methods. These inking assemblies all employ a handle assembly, an inking assembly, and a stamp member or wheel. The handle assembly is displaced such that the stamp wheel rolls along an inking surface; the handle assembly further supports the inking assembly and the stamp member such that the inking assembly continuously applies ink to the stamp wheel as the inking wheel rolls along the inking surface.

The ink image formed by conventional inking systems is defined by the design on the stamp member or wheel. Conventional continuous inking systems, including the systems described in the '526, '007, and '954 patents described above, allow the stamp member or wheel to be removed and replaced with a stamp member with a different image design.

In particular, FIGS. 1-3 illustrate a continuous ink stamping system 20 as disclosed in U.S. Pat. No. 7,195,954, the contents of which are incorporated herein by reference. The example ink stamping system 20 is used in a conventional manner to form ink images 22 on a surface 24.

The stamping system 20 comprises a handle assembly 30, a stamp wheel assembly 32, and an inking system 34. The handle assembly 30 rotatably supports the stamp wheel assembly 32. The inking system 34 is mounted within the handle assembly 30 such that ink is applied to the stamp wheel assembly 32 as the stamp wheel assembly 32 rotates.

The handle assembly 30 defines a wheel opening 40 circumscribed by an opening edge 42. The opening edge 42 further defines wheel notches 50 and a cartridge notch 52. The wheel notches 50 support the stamp wheel assembly 32, while the cartridge notch 52 facilitates access to portions of the inking system 34. The stamp wheel assembly 32 comprises a drum portion 60, a wheel axle portion 62, and spoke portions 64. The example wheel axle portion 62 is substantially cylindrical.

Outer portions 66 of the axle portion 62 are sized and dimensioned to be snugly received within the wheel notches 50. More specifically, the outer portions 66 snap into the wheel notches 50 to allow the stamp wheel assembly 32 to be detachably attached to the handle assembly 30. With the outer portions 66 so received by the wheel notches 50, the wheel assembly 32 is centered relative to the wheel opening 40, and the wheel assembly 32 can rotate about the axis of the axle portion 62 relative to the handle assembly 30.

A stamp portion 70 is formed on the drum portion 60. The example stamp portion 70 is a layer of rubber stamp material defining a stamp surface 72. The image 22 is formed in bas relief on the stamp surface 72 in a conventional manner. Different wheel assemblies can be attached to the handle assembly 30 to obtain different images 22.

As best shown in FIG. 3, the example inking system 34 comprises an ink wheel 80, an ink housing 82, a rod 84, and a spring 86. The ink housing 82 supports the ink wheel 80, and the handle assembly 30 supports the ink housing 82 for movement between a retracted position (not shown) and an inking position (FIG. 3). The spring 86 acts on the rod 84 and the rod 84 in turn acts on the ink housing 82 to bias the ink housing 82 and ink wheel 80 towards the wheel assembly 32. In the retracted position, the ink housing 82 engages the handle assembly 30 such that the ink wheel 80 is held away from the wheel assembly 32. In the inking position, the spring 86 forces the ink wheel 80 against the wheel assembly 32 such that ink on the ink wheel 80 is transferred to the stamp surface 72.

The need thus exists for ink stamping systems that provide the user with more flexibility in the formation of ink images.

### SUMMARY

The present invention may be embodied as an ink stamping system comprising a handle assembly and a stamp wheel assembly. The stamp wheel assembly comprises an axle assembly supported by the handle assembly and at least two wheel members. Each of the at least two wheel members defines a stamp surface. The at least two wheel members are supported by the axle assembly in first and second configurations. In the first configuration, the at least two wheel members supported by the axle assembly in the first configuration define a first angular relationship, and the stamp surfaces of the at least two wheel members supported by the axle assembly in the first configuration define a first ink image. In the second configuration, the at least two wheel members supported by the axle assembly in the second configuration define a second angular relationship and the stamp surfaces of the at least two wheel members supported by the axle assembly in the second configuration define a second ink image. The first and second ink images are different.

The present invention may also be embodied as a stamp wheel assembly adapted for use as part of an ink stamp system, the stamp wheel assembly comprising an axle assembly and first, second, and third wheel members. Each of the first, second, and third wheel members defines a stamp surface. At least two of the first, second, and third wheel members are supported by the axle assembly in a plurality of configurations. At least two of the first, second, and third wheel members are supported by the axle assembly in the plurality of configurations to define a plurality of angular relationships among the at least two of the first, second and third wheel members. The stamp surfaces of the at least two of the first, second, and third wheel members supported by the axle assembly in the plurality of configurations define a plurality of ink images. At least two of the plurality of ink images are unique.

The present invention may also be embodied as a method of forming a plurality of ink images comprising the following steps. An axle assembly is supported on a handle assembly. First, second, and third wheel members are provided, where each of the first, second, and third wheel members defines a stamp surface. At least two of the first, second, and third wheel members are supported on the axle assembly in the plurality of configurations to define a plurality of angular relationships among the at least two of the first, second and third wheel members. Ink is applied to the stamp surfaces in at least two of the plurality of configurations. The handle assembly is displaced such that the stamp surfaces of the at least two of the first, second, and third wheel members supported by the axle assembly in the plurality of configurations form a plurality of ink images. At least two of the plurality of ink images are unique.

### DESCRIPTION OF THE DRAWINGS

FIG. 1 is a side elevation view depicting an example prior art continuous ink stamping system;

FIG. 2 is a bottom plan view of the ink stamping system of FIG. 1;

FIG. 3 is a partial cutaway, side elevation view of a handle assembly of the ink stamping system of FIG. 1 illustrating an inking assembly thereof in an engaging position;

FIG. 4 is a bottom plan view of an example ink stamping system containing a reconfigurable stamp wheel assembly of the present invention;

FIG. 5 is a partial cutaway, side elevation view of the ink stamping system of FIG. 4 illustrating an inking assembly thereof in an engaging position;

FIG. 6 is an exploded view of a stamp assembly that may be used with an ink stamping system of FIGS. 4 and 5;

FIG. 7 is a side elevation view of a wheel member of the stamp assembly of FIGS. 4 and 5;

FIG. 8 is a side elevation view of an axle member of the stamp assembly of FIGS. 4 and 5; and

FIGS. 9 and 10 are plan views of the wheel assembly of FIGS. 4 and 5 in first and second configurations.

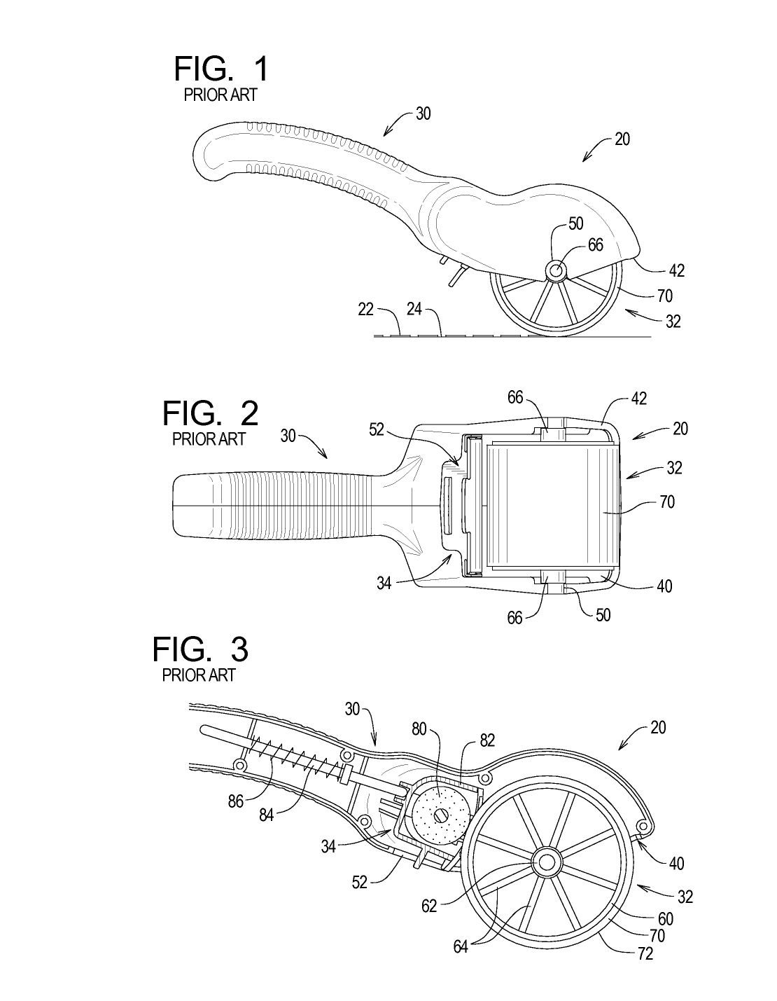

### DETAILED DESCRIPTION

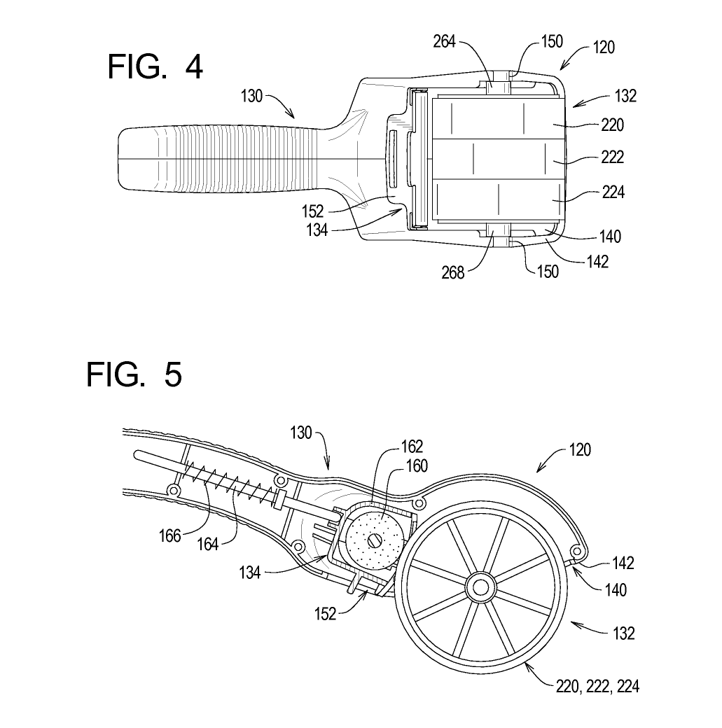

Turning now to FIGS. 4-10 of the drawings, depicted therein is an example continuous ink stamping system 120 constructed in accordance with, and embodying, the principles of the present invention. Like the stamping system 20 described above, the example stamping system 120 is used in a conventional manner to form ink images on a surface. The example ink stamping system 120 employs certain common elements with the conventional ink stamping system 20 described above and will be described herein only to that extent necessary for a complete understanding of the present invention.

The stamping system 120 comprises a handle assembly 130, a stamp wheel assembly 132, and an inking system 134. The handle assembly 130 rotatably supports the stamp wheel assembly 132. The inking system 134 is mounted within the handle assembly 130 such that ink is applied to the stamp wheel assembly 132 as the stamp wheel assembly 132 rotates.

The handle assembly 130 defines a wheel opening 140 circumscribed by an opening edge 142. The opening edge 142 further defines wheel notches 150 and a cartridge notch 152. The wheel notches 150 support the stamp wheel assembly 132, while the cartridge notch 152 facilitates access to portions of the inking system 134.

As best shown in FIG. 4, the example inking system 134 comprises an ink wheel 160, an ink housing 162, a rod 164, and a spring 166. The ink housing 162 supports the ink wheel 160, and the handle assembly 130 supports the ink housing 162 for movement between a retracted position (not shown) and an inking position (FIG. 5). The spring 166 acts on the rod 164 and the rod 164 in turn acts on the ink housing 162 to bias the ink housing 162 and ink wheel 160 towards the wheel assembly 132. In the retracted position, the ink housing 162 engages the handle assembly 130 such that the ink wheel 160 is held away from the wheel assembly 132. In the inking position, the spring 166 forces the ink wheel 160 against the wheel assembly 132 such that ink on the ink wheel 160 is transferred to wheel assembly 132 as will be described in further detail below.

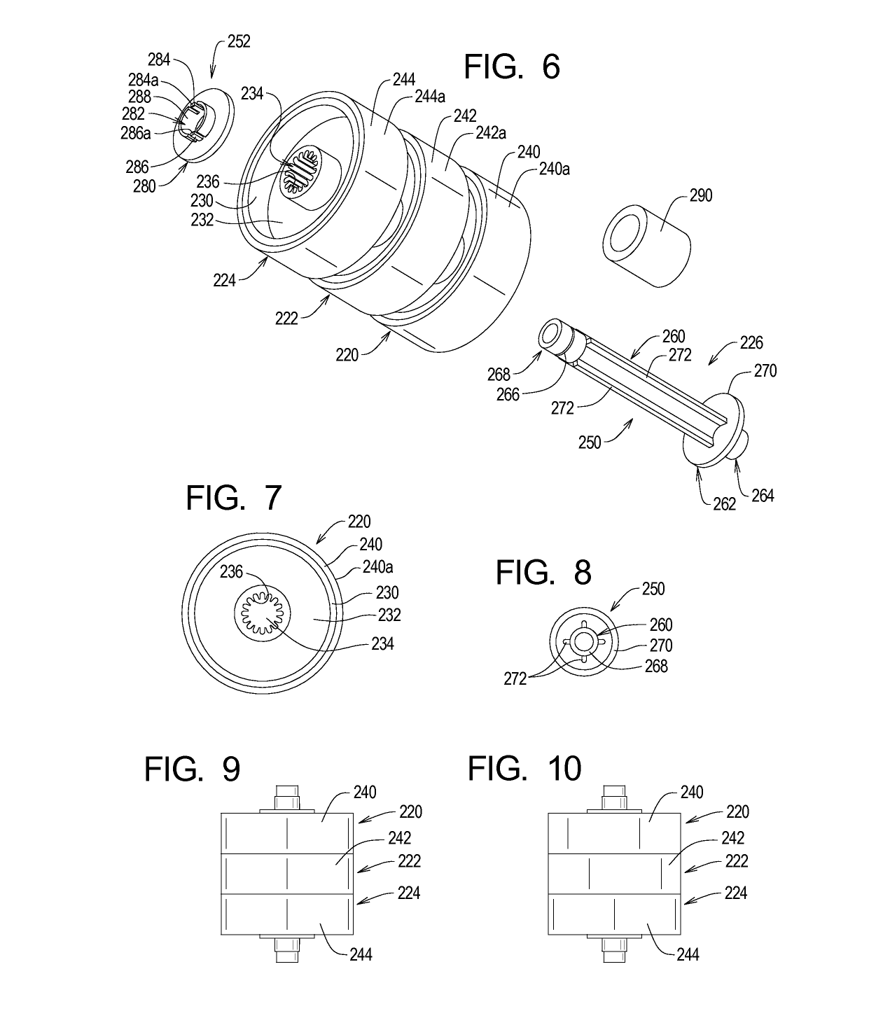

As shown in FIGS. 6-10, the example stamp wheel assembly 132 comprises a plurality of wheel members 220, 222, and 224 and an axle assembly 226. The wheel members 220, 222, and 224 each comprise a drum portion 230 and a spacing portion 232. The drum portions 230 are substantially cylindrical and each define an axle opening 234 centered about a longitudinal axis defined by the drum portions 230. A plurality of wheel teeth 236 extend radially inwardly from the drum portions 230 into the axle opening 234.

The wheel assembly 132 further comprises stamp members 240, 242, and 244. The example stamp members 240, 242, and 244 are formed by a layer of rubber stamp material defining stamp surfaces 240a, 242a, and 244a. The stamp members 240, 242, and 244 are adhered to the outer surfaces of the drum portions 230 of the wheel members 220, 222, and 224, respectively. The images created by the individual stamp members 240, 242, and 244 are formed in bas relief on the stamp surfaces 240a, 242a, and 244a in a conventional manner.

As best shown in FIG. 6, the axle assembly 226 comprises an axle member 250 and an axle cap 252. The axle member 250 comprises a shaft 260 and a retaining portion 262 formed adjacent to a first end 264 of the shaft 260. A groove 266 extends around a second end 268 of the shaft 260.

The ends 264 and 268 of the axle member 250 are sized and dimensioned to be received within the wheel notches 150. More specifically, the ends 264 and 268 snap into the wheel notches 150 to allow the stamp wheel assembly 132 to be detachably attached to the handle assembly 130. With the ends 264 and 268 so received by the wheel notches 150, the wheel assembly 132 is substantially centered relative to the wheel opening 140, and the axle assembly 226 is capable of rotating relative to the handle assembly 130 about the longitudinal axis of the axle assembly 226.

The retaining portion 262 of the axle member 250 defines a first retaining flange 270. Further, a plurality of axle teeth 272 radially extend from the shaft 260 between the retaining portion 262 and the groove 266. The term “plurality” is used herein to refer more than one of a given element but does not imply that more than two such elements are required even if an example described herein employs more than two elements.

The axle cap 252 defines a second retaining flange portion 280 and a connecting portion 282. Formed in the connecting portion 282 are first and second detent portions 284 and 286. The axle cap 252 defines a cap opening 288 sized and dimensioned to receive the second end 268 of the shaft 260.

The axle cap 252 is detachably attached to the axle member 250 by inserting the second end 268 of the shaft 260 into the axle opening 234 such that lock portions 284a and 286a of the detent portions 284 and 286 extend into the groove 266 in the shaft 260. To remove the axle cap 252 from the axle member 250, the detent portions 284 and 286 are deformed such that the lock portions 284a and 286a do not extend into the groove 266, at which point the shaft second end 268 may be removed from the cap opening 288.

In use, the axle cap 252 is initially detached from the axle member 250 if necessary. The axle member 250 is then displaced such that the shaft second end 268 extends through the axle openings 234 defined by one, two, or three of the wheel members 220, 222, and 224. The axle cap 252 is then reattached such that the wheel members 220, 222, and/or 224 are held between the first and second retaining flange portions 270 and 280 to form the wheel assembly 132. The axle assembly 226 is then displaced such that the ends 264 and 268 engage the wheel notches 150 to detachably attach the wheel assembly 132 to the handle assembly 130. The inking system 120 may then be used conventionally to form an ink image on an inking surface.

From the foregoing, it should be apparent that one, two, or all three of the wheel members 220, 222, and 224 may be arranged on the axle member 250 in various configurations. If less than three of the wheel members 220, 222, and 224 are used, one or two optional cylindrical spacers 290 (FIG. 6) can be arranged on the axle member 250 to maintain a location of the wheel members along the longitudinal axis of the axle member 250.

Accordingly, one, two, or three of the example wheel members 220, 222, and 224 may be arranged in any position relative to each other along the longitudinal axis of the axle assembly 226. By simply using fewer than three wheel members or switching the locations of the wheel members, the user of the stamping system 120 has numerous options for the look of the image formed by the system 120.

Additionally, the angular positions of the wheel members 220, 222, and 224 may also be configured as desired. In particular, when the shaft portion 260 of the axle member 250 is arranged within the axle openings 234 of the wheel members 220, 222, and 224, the wheel teeth 236 of the wheel members 220, 222, and 224 engage axle teeth 272 of the axle member 250 to fix an angular location of each of the wheel members 220, 222, and 224 relative to the axle member 250.

Accordingly, by selecting an angular position of each of the wheel members 220, 222, and 224 relative to each other as the wheel members 220, 222, and 224 are arranged on the axle member 250, the user can select a desired angular relationship among the various wheel members 220, 222, and 224. For example, a first angular relationship among the wheel members 220, 222, and 224 is depicted in FIG. 9; a second angular relationship among the wheel members 220, 222, and 224 is depicted in FIG. 10.

The inking system 120 thus allows the user significant flexibility to make different ink images with three wheel members 220, 222, and 224. The inking system 120 can be further customized by providing more than three wheel members, and wheel members of different widths can be used for increased flexibility.

The present invention has been described in the context of a handle assembly 30 such as that described in U.S. Pat. No. 7,195,954. However, the wheel assembly 132 described herein can be used in conjunction with handle assemblies of different configurations. As examples, the principles of the present invention can be applied to handle assemblies such as those described in U.S. Pat. Nos. 4,817,526 and 6,659,007, the contents of which are also incorporated herein by reference. Additionally, it may be possible to implement the present invention in an ink stamping system in which the ink is applied to the stamping surface from an external source such as a stand-alone ink pad. In this case, the internal inking system may be unused or omitted.

From the foregoing, it should be apparent that the present invention may be embodied in many different combinations and sub-combinations of the elements and steps described above. The scope of the present invention should thus be determined by the following claims and not the foregoing detailed description.

What is claimed is:

1. An ink stamping system comprising:
a handle assembly; and
a stamp wheel assembly comprising
an axle assembly supported by the handle assembly, and
at least two wheel members, where each of the at least two wheel members defines a stamp surface; wherein
the at least two wheel members are supported by the axle assembly in first and second configurations, where
in the first configuration,
the at least two wheel members supported by the axle assembly in the first configuration define a first angular relationship, and
the stamp surfaces of the at least two wheel members supported by the axle assembly in the first configuration define a first ink image;
in the second configuration,
the at least two wheel members supported by the axle assembly in the second configuration define a second angular relationship, and
the stamp surfaces of the at least two wheel members supported by the axle assembly in the second configuration define a second ink image; and
the first and second ink images are different.

2. An ink stamp system as recited in claim 1, in which:
the stamp wheel assembly comprises more than two wheel members; and
more than two wheel members are supported by the axle assembly in more than two configurations.

3. An ink stamp system as recited in claim 1, in which the axle assembly engages the wheel members such that an angular relationship between the axle assembly and the wheel members is fixed.

4. An ink stamp system as recited in claim 1, in which the axle assembly comprises:
an axle member for supporting the wheel members; and
an axle cap; wherein
the axle cap is detached from the axle member to allow the wheel members to be removed from the axle member; and
the axle cap is attached to the axle member to inhibit removal of the wheel members from the axle member.

5. An ink stamp system as recited in claim 4, in which the axle member engages the wheel members such that an angular relationship between the axle assembly and the wheel members is fixed.

6. An ink stamp system as recited in claim 4, in which:
a first retaining flange is formed on a first end the axle member; and
a second retaining flange is formed on the axle cap; and
the axle cap is detachably attached to a second end of the axle member to form the axle assembly.

7. An ink stamp system as recited in claim 6, in which:
a groove is formed on the second end of the axle member;
at least one detent portion is formed on the axle cap; and
the at least one detent portion engages the groove to detachably attach the axle cap to the second end of the axle member to form the axle assembly.

8. An ink stamp system as recited in claim 1, in which the axle assembly comprises:
at least one axle member, where at least one axle tooth is formed on the axle member;
a plurality of wheel teeth are formed on each of the wheel members; and
the at least one axle tooth engages two of the wheel teeth of each of the at least two wheel members supported by the axle assembly to fix the angular relationship between the axle assembly and each of the at least two wheel members supported thereby.

9. An ink stamp system as recited in claim 1, further comprising at least one spacer, where the at least one spacer is supported by the axle assembly to maintain a location of the at least two wheel members along a longitudinal axis defined by the axle assembly.

10. An ink stamp system as recited in claim 1, further comprising an inking system supported by the handle assembly to apply ink to the stamp surfaces as the wheel members rotate relative to the handle assembly.

11. A stamp wheel assembly adapted for use as part of an ink stamp system, the stamp wheel assembly comprising:
an axle assembly; and
first, second, and third wheel members, where each of the first, second, and third wheel members defines a stamp surface; wherein
at least two of the first, second, and third wheel members are supported by the axle assembly in a plurality of configurations, where
at least two of the first, second, and third wheel members are supported by the axle assembly in the plurality of configurations to define a plurality of angular relationships among the at least two of the first, second and third wheel members, and
the stamp surfaces of the at least two of the first, second, and third wheel members supported by the axle assembly in the plurality of configurations define a plurality of ink images; and
at least two of the plurality of ink images are unique.

12. A stamp wheel assembly as recited in claim 11, in which the axle assembly engages the wheel members such that an angular relationship between the axle assembly and the wheel members is fixed.

13. A stamp wheel assembly as recited in claim 12, in which the axle assembly comprises:
an axle member for supporting the wheel members; and
an axle cap; wherein
the axle cap is detached from the axle member to allow the wheel members to be removed from the axle member; and
the axle cap is attached to the axle member to inhibit removal of the wheel members from the axle member.

14. A stamp wheel assembly as recited in claim 13, in which the axle member engages the wheel members such that an angular relationship between the axle assembly and the wheel members is fixed.

15. A stamp wheel assembly as recited in claim 13, in which:
a first retaining flange is formed on a first end of the axle member; and
a second retaining flange is formed on the axle cap; and
the axle cap is detachably attached to a second end of the axle member to form the axle assembly.

16. A stamp wheel assembly as recited in claim 15, in which:
a groove is formed on the second end of the axle member;
at least one detent portion is formed on the axle cap; and
the at least one detent portion engages the groove to detachably attach the axle cap to the second end of the axle member to form the axle assembly.

17. A stamp wheel assembly as recited in claim 11, in which the axle assembly comprises:
at least one axle member, where at least one axle tooth is formed on the axle member;
a plurality of wheel teeth are formed on each of the wheel members; and
the at least one axle tooth engages two of the wheel teeth of each of the at least two wheel members supported by the axle assembly to fix the angular relationship between the axle assembly and each of the at least two wheel members supported thereby.

18. A stamp wheel assembly as recited in claim 11, in which the axle assembly comprises:
at least one axle member, where a plurality of axle teeth are formed on the axle member;
a plurality of wheel teeth are formed on each of the wheel members; and
each of the axle teeth engages two of the wheel teeth of each of the at least two wheel members supported by the axle assembly to fix the angular relationship between the axle assembly and each of the at least two wheel members supported thereby.

19. A stamp wheel assembly as recited in claim 11, further comprising at least one spacer, where the at least one spacer is supported by the axle assembly to maintain a location of the at least two wheel members along a longitudinal axis defined by the axle assembly.

20. A method of forming a plurality of ink images, comprising the steps of:
providing a handle assembly;
supporting an axle assembly on the handle assembly;
providing first, second, and third wheel members, where each of the first, second, and third wheel members defines a stamp surface;
supporting at least two of the first, second, and third wheel members on the axle assembly in the plurality of configurations to define a plurality of angular relationships among the at least two of the first, second and third wheel members;
applying ink to the stamp surfaces in at least two of the plurality of configurations;
displacing the handle assembly such that the stamp surfaces of the at least two of the first, second, and third wheel members supported by the axle assembly in the plurality of configurations form a plurality of ink images, where at least two of the plurality of ink images are unique.
